(19) United States
(12) Patent Application Publication
(10) Pub. No.: US 2017/0099980 A1
(43) Pub. Date: Apr. 13, 2017

(54) INTEGRATED TABLET COMPUTER IN HOT AND COLD DISPENSING MACHINE

(71) Applicants: Michel Abou Haidar, Corona, CA (US); Eddie E. Feghali, Corona, CA (US)

(72) Inventors: Michel Abou Haidar, Corona, CA (US); Eddie E. Feghali, Corona, CA (US)

(21) Appl. No.: 15/279,176

(22) Filed: Sep. 28, 2016

Related U.S. Application Data
(60) Provisional application No. 62/238,900, filed on Oct. 8, 2015.

(51) Int. Cl. A47J 31/44; G06K 7/14; B67D 7/10; A47J 31/42; B01F 3/04; G06K 7/10; G06Q 30/02

(52) U.S. Cl. CPC A47J 31/44; G06K 7/10722; G06K 7/1417; G06Q 30/0241; A47J 31/42; B01F 3/04808; B67D 7/10; B01F 2003/049

(57) ABSTRACT

Improvements a hot and cold dispensing machine is disclosed. The machine integrates a tablet computer with hot and cold dispensing machines, including Coffee machines that transform the dispensing machine into a fully interactive machine that enables an unlimited number of features to be added as functionalities. Computers are easy to use, multitasking, enable connection to internet, and provide access to all social media networks. The user will enjoy all of a computer's powerful features when configuring their profile on the machines from watching a commercial that push advertisement or even live TV while waiting for their drink. The information on the tablet can be shared with other dispensing machines and remembers previous and preferred preferences. The machine can also suggest other combinations based up on the user and similar user's selections.

### CROSS REFERENCE TO RELATED APPLICATIONS

This application claims the benefit of Provisional Application Ser. No. 63/238,900 filed Oct. 8, 2016 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

Field of the Invention

This invention relates to improvements in a hot and cold beverage dispenser. More particularly, the present hot and cold beverage dispenser integrates a personal computing device with a tablet or android computing platform on any coffee machine (Home, commercial or vending) as well as any dispensing machine for hot and cold beverages.

Description of Related Art Including Information Disclosed Under 37 CFR 1.97 and 1.98.

Creating an intuitive user interface for a hot and cold beverage dispenser such as a coffee machine is not an easy task especially when the machine should function as a normal computer with the expected computing capabilities. Capacitive Touch screens are considered the standard for simple user touch interface and most users expect the same simple touch screen user interface in nearly all aspects of machines they use and interface with a computing system in a method mobile computing users are familiar.

The complex database structure keeps track of every customer's profile, and for every profile its picture, products and recipes for each product, the interactivity using a Web cam, microphone and live video chatting, makes the integration of Android in a Coffee machine or any Hot or Cold dispensing beverage machine is not found in hot and cold beverage dispensers.

Each person has a different taste, and would like to personalize his recipes. Studies show that no two tastes are the same. It is time to present to the customer the possibility to customize his beverage, moreover to save them for further use at his convenience and the ability to change/modify when desired.

A number of patents and or publications have been made to address these issues. Exemplary examples of patents and or publication that try to address this/these problem(s) are identified and discussed below.

U.S. Published application 20120164422 was published on Jun. 27, 2013 for Arren J. McCormick discloses a Coffee Maker Supporting Single Serve & Carafe Operations. There are a number of coffee makers that produce just a single cup of coffee that is made from a single serving concentrated liquid coffee concentrate. This publication creates a bridge between a coffee machine that prepares a single cup and a full pot of coffee. While this publication discloses a machine that can produce one or several cups of coffee, it does not have a user interface that remembers the user preference for the coffee.

U.S. Published application 2012/0037008 was published on Feb. 16, 2012 to Nelson Antonio Rodriguez discloses a Programmable Multiple Ingredient Dispensing Coffee Maker with Customizable Settings for Multiple Individual Preferences. This application discloses a coffee maker that can dispense multiple ingredients into the coffee that is being prepared, but a user must program the coffee maker each time they brew a separate cup.

U.S. Published application 2004/0118294 was published on Jun. 24, 2004 for Wade L. Grassedonio discloses a Semi-automated Coffee Maker. The coffee make uses a bank of separate coffee chambers that index to fill a coffee pot multiple times. The automated portion of the coffee maker still required a user to pre-install multiple coffee packets prior to use of the coffee machine.

What is needed is a hot and cold beverage dispenser that covers the use of any liquid cartridge in any form in order to dispense Flavors, Syrup, Liquid sugar of all kinds, and tea essence in the coffee dispenser. A tablet computer will be used to run the machine as well as to offer all the facilities of a computer or a tablet. The proposed hot and cold beverage dispenser provides a solution to this problem.

### BRIEF SUMMARY OF THE INVENTION

It is an object of the integrated tablet in a hot and cold dispensing machine to use of any liquid cartridges, in any form in order to dispense Flavors, Syrup, Liquid sugar of all kinds, and tea essence in the coffee dispenser.

It is an object of the integrated tablet in a hot and cold dispensing machine for the cartridges to be operated by special peristaltic pumps that prevent cross contamination.

It is another object of the integrated tablet in a hot and cold dispensing machine to be controlled by a tablet computer such as an android based computer that is used to run the machine as well as to offer all the facilities of a computer or a tablet.

It is still another object of the integrated tablet in a hot and cold dispensing machine for the tablet computer to include, but not limit the functions of executing commands, dispensing recipes, creating, deleting and editing user profiles, changing system settings, connecting to the internet, accessing social media networks, providing music playing, radio playing, video playing, registering audio/video messages, reading QR codes via built in cam or an external reader, reading boarding pass codes used in airlines companies for identifying the user and customizing each recipe for each user profile.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a tablet computer controlling the coffee machine.

FIG. 2 described the use of liquid flavor cartridges.

FIG. 3 shows a first preferred embodiment of a control diagram.

FIG. 4 shows a second preferred embodiment of a control diagram.

FIG. 5 shows a third preferred embodiment of a control diagram.

### DETAILED DESCRIPTION OF THE INVENTION

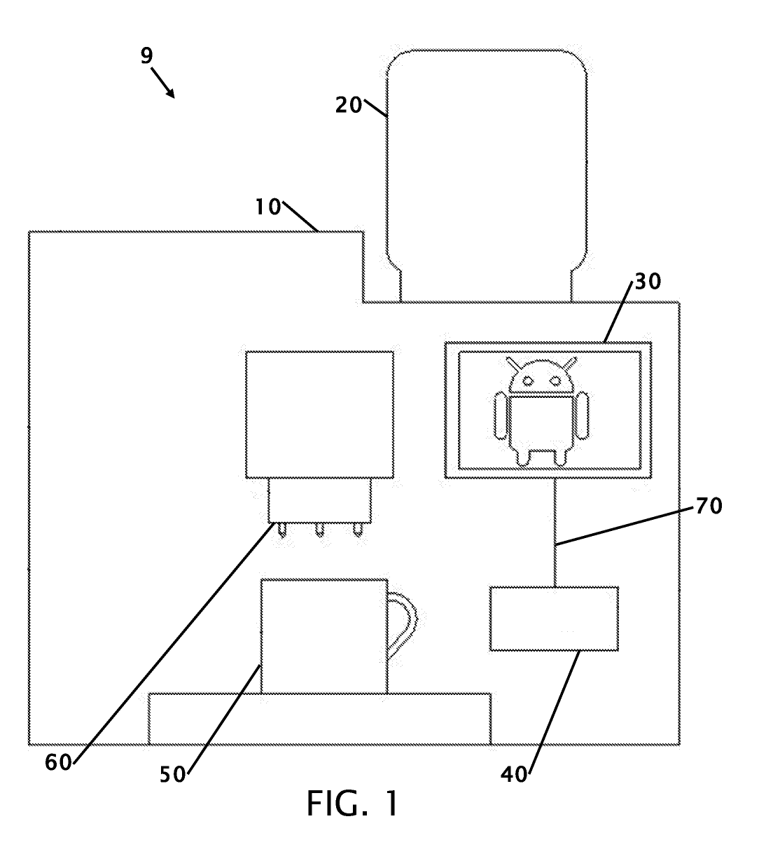

FIG. 1 shows a tablet computer controlling the coffee machine 9. It is a main objective of the coffee maker 9 to provide an improved interface for the dispensing machine user to customize his drinks, save them, change and edit them at his convenience. The coffee maker 9 offers internet connectivity and transforming the dispensing machine into a “Smart Multifunctional Dispensing” machine. The tablet 30 receives publicity ads, whether pushed ads or online, makes the dispensing/coffee machine more attractive and can transmit useful information to the user while waiting for brewing/dispensing their drink. The user can be identified by a QR code or by a boarding pass code in an airport, will help retrieving the user's profile from remote server immediately so that he can have his preferred drink.

In the preferred embodiment shown in FIG. 1, the coffee machine 9 in contained in a housing 10. The housing is constructed in a rigid configuration out of metals and plastics that are sufficiently sized to include the requirements of the machine 9. The overall size and shape of the housing 10 can be adjusted based upon the desired internal features and refill interval. This embodiment shows a coffee bean container 20 that houses the beans that are ground for brewing. While this embodiment shows only one bean container it is contemplated that several different beans can be include or changed based upon the season or user preferences. The user interface 30 is shown as a tablet computer operating an Android operating system and user interface. While an Android user interface is shown and described it is contemplated that other operating systems including but not limited to Windows, Apple or others can be used without altering the functionality of the coffee machine 9.

The tablet computer 30 connects with the coffee machine 9 with a I²C serial communication 70 or other equivalent wired or wireless communication connection including but not limited to blue tooth, Wi-Fi, G3, G4 and RF and infrared. A controller 40 receives the brew command from the tablet computer to control the brewing and mixing of the user specified hot or cold beverage.

The tablet computer 30 functions include, but are not limit the functions of executing commands, dispensing recipes, creating, deleting and editing user profiles, changing system settings, connecting to the internet, accessing social media networks, providing music playing, radio playing, video playing, registering audio/video messages, reading QR codes via built in camera or an external reader, reading boarding pass codes used in airlines companies for identifying the user, customizing each recipe for each user profile to produce the desired, preferred or familiar taste.

A user simple places a cup 50 into the coffee machine 9, identifies their preference and the coffee machine 9 dispenses the hot or cold beverage from the nozzle(s) 60. The user may use their own cup 50 or disposable cups can be used. The coffee machine 9 includes sensors that determine the appropriate amount of beverage within the cup 50. If payment is required the tablet computer 30 can debit an account from a user based upon the information created by the user. This eliminates the need of a user at an airport to locate and use a credit or debit card. A grinder can grind coffee beans to a powder so coffee can be brewed. The figures show that one or more coffee beans can be used.

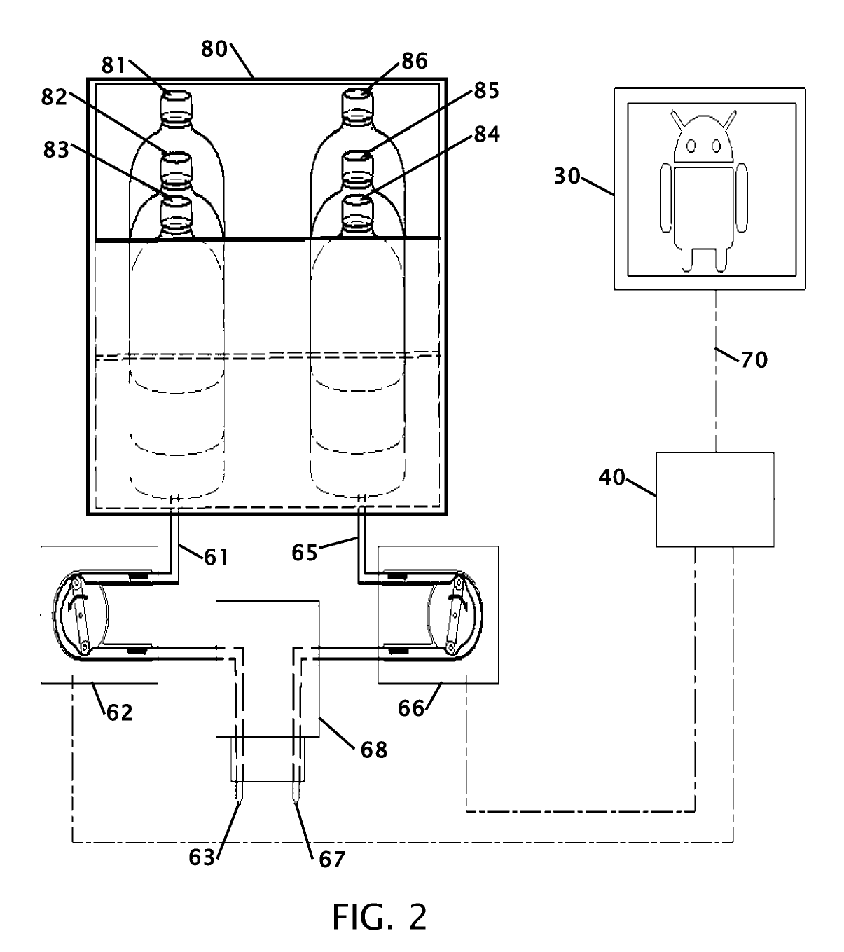

FIG. 2 described the use of liquid flavor cartridges that use special pumps to dispense syrups, flavors, liquid sugar (of all kinds) from the liquid cartridges 81-86. The liquid cartridges are housed in a protective cover or housing 80 that prevents tampering or contamination. It is also contemplated that the liquids can include carbonation or CO2 gas to provide a greater number of cold beverages. The tablet computer 30 provides the user interface, stores and retrieves the information from users that locally use the machine 9 and can retrieve information from a user that visits the machine from another country using an Internet connection. In one contemplated embodiment, a user identifies them to the tablet computer 30. The tablet computer can have several different methods to identify a user including but not limited to voice print, finger print, ID badge, airplane ticket, credit/ID card or other.

The tablet computer recalls the preferences and communicates 70 to the controller 40 of the specific mixture communicated. The controller 40 operates peristaltic pump or pumps 62, 66 that draws fluid from the cartridges 81-96 through silicon pipe 61, 65 tubes or equivalent out to the dispensing nozzle(s) 63, 67. A thermoelectric device 68 and or thermal heater heats or cools the water and/or fluids prior to being dispensed. The dispensing temperature can also be a selectable option that a user can select from the tablet computer 30 user interfaces. While the brewing and dispensing is taking place a user can interface with the tablet computer to view advertisement, read email or perform other functions that they are able to perform with a computer, tablet or phone.

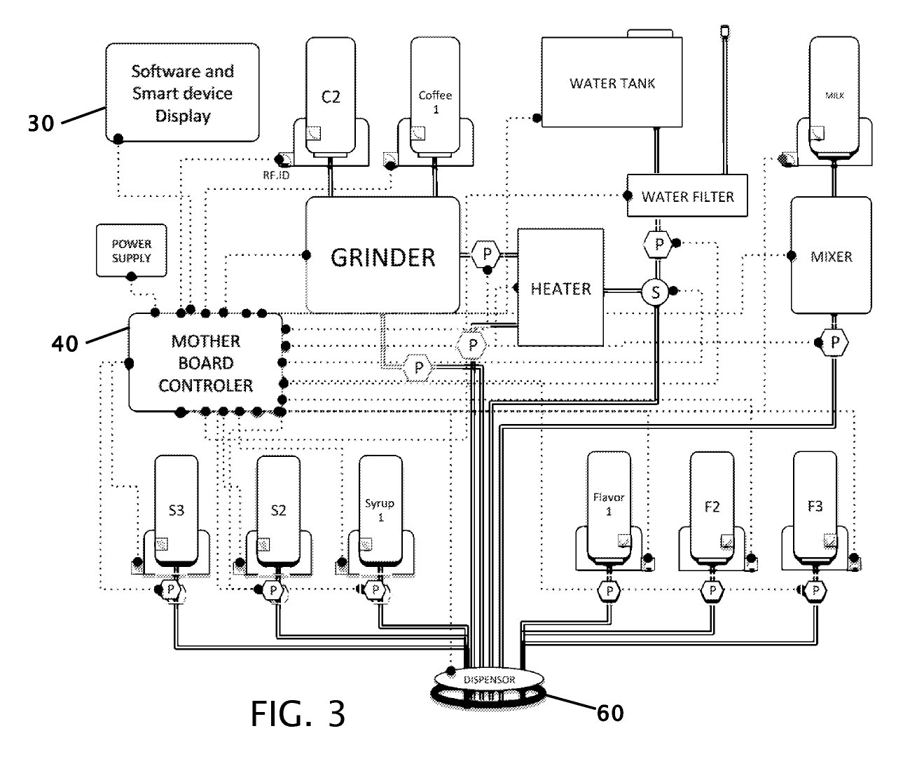

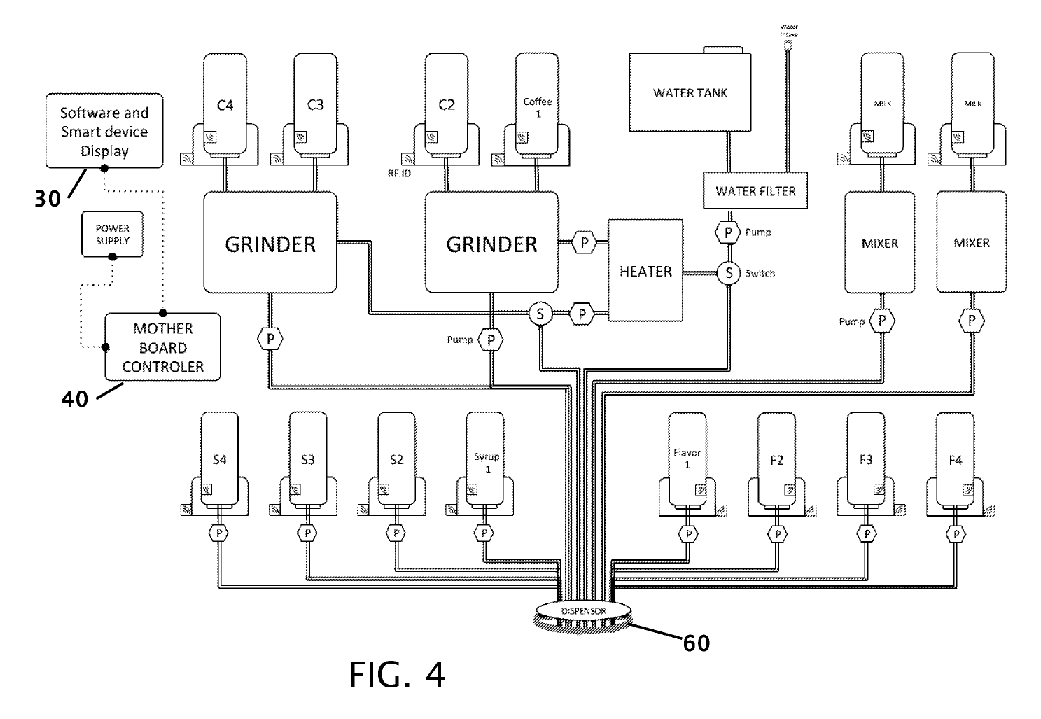

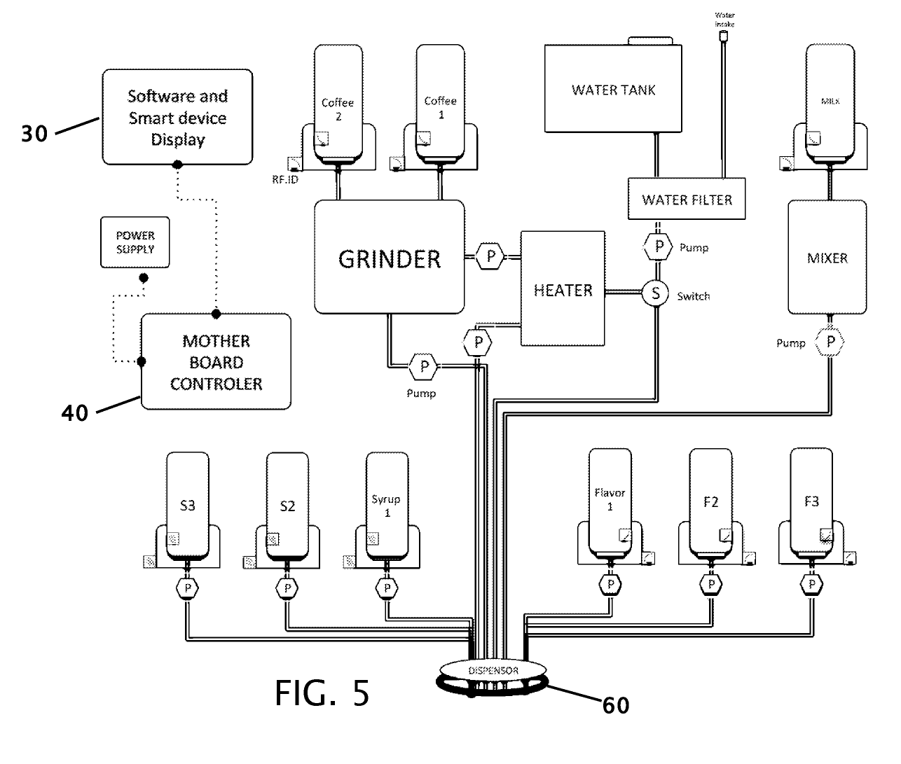

FIG. 3 shows a first preferred embodiment of a control diagram, FIG. 4 shows a second preferred embodiment of a control diagram and FIG. 5 shows a third preferred embodiment of a control diagram.

The beverage dispenser produces hot or cold beverages using a thermoelectric device. The dispensing machine has a connection interface from integration of a portable computing device. The portable computing device is a computer, tablet or a cell phone that has wired and/or wireless connection to an internet blue tooth, Wi-Fi, G3, G4 and RF, infrared or other communications interface.

The portable computing device has a user interface that allows a user to interact with said portable computing device, and the portable computing device stores said used preferences. A user is recognized by voice print, finger print, ID badge, airplane ticket, credit/ID card or other.

Thus, specific embodiments of a hot and cold beverage dispenser have been disclosed. It should be apparent, however, to those skilled in the art that many more modifications besides those described are possible without departing from the inventive concepts herein. The inventive subject matter, therefore, is not to be restricted except in the spirit of the appended claims.

1. A beverage dispenser comprising:
a hot or cold beverage dispensing machine;
a connection interface from integration of a portable computing device;
said portable computing device having a user interface that allows a user to interact with said portable computing device, and
said portable computing device stores said used preferences.

2. The beverage dispenser according to claim 1 wherein said portable computing device is an android based portable computing device.

3. The beverage dispenser according to claim 1 wherein said portable computing device communicates with at least one separate beverage dispense said user preferences.

4. The beverage dispenser according to claim 1 wherein said portable computing device includes an advertisement activity that pushed advertisement, live advertisement, live videos, connection to TV stations, connection to Radio stations.

5. The beverage dispenser according to claim 1 wherein said portable computing device integrates a social media networking facility of a group consisting of Skype, Yahoo messenger, Facebook or Twitter.

6. The beverage dispenser according to claim 1 that further includes voice command interaction and voice response.

7. The beverage dispenser according to claim 1 that further includes QR code reading from a camera or a special QR Reader.

8. The beverage dispenser according to claim 1 that further includes a reader that reads airline boarding pass codes used for identifying said user for further processing.

9. The beverage dispenser according to claim 1 that uses liquid cartridges to dispense from a group consisting of flavors, syrup, liquid sugar, tea or coffee.

10. The beverage dispenser according to claim 1 that provides said dispensed beverage at a hot, cold or room temperate that is uniquely set by each said user.

11. The beverage dispenser according to claim 1 wherein said portable computing device includes wired and/or wireless connection to an internet.

12. The beverage dispenser according to claim 11 wherein said wire and/or wireless connection to the internet is selected from a group consisting of blue tooth, Wi-Fi, G3, G4 and RF and infrared.

13. The beverage dispenser according to claim 1 wherein said portable computing device includes at least one user identifier selected from a group consisting of voice print, finger print, ID badge, airplane ticket, credit or ID card.

14. The beverage dispenser according to claim 1 includes a thermoelectric device to heat or cool fluid.

15. The beverage dispenser according to claim 1 wherein said portable computing device is a computer, tablet or a cell phone.

16. The beverage dispenser according to claim 1 further includes a carbonation or CO2 gas dispenser.

17. The beverage dispenser according to claim 1 further includes an interface that stores and retrieves information and preferences from users.

18. The beverage dispenser according to claim 17 further includes suggests of other combinations based up on combinations or mixtures from other users.

19. The beverage dispenser according to claim 1 further includes a plurality of peristaltic pumps that prevent cross contamination.

20. The beverage dispenser according to claim 1 further includes a grinder.
